(19) United States
(12) Patent Application Publication
(10) Pub. No.: US 2011/0185178 A1
(43) Pub. Date: Jul. 28, 2011

(54) COMMUNICATION METHOD OF AN ELECTRONIC HEALTH INSURANCE CARD WITH A READING DEVICE

(75) Inventor: Frank Gotthardt, Eitelborn (DE)

(73) Assignee: COMPUGROUP HOLDING AG, Koblenz (DE)

(21) Appl. No.: 12/935,008

(22) PCT Filed: Feb. 16, 2009
(86) PCT No.: PCT/EP09/51817

§ 371 Date: Jan. 10, 2011

(30) Foreign Application Priority Data
Mar. 31, 2008 (DE) 20 2008 000 897.4

(51) Int. Cl. H04L 9/32

(52) U.S. Cl. 713/172

(57) ABSTRACT

The invention relates to a communication method of an electronic health insurance card (122) with a reading device. A communication link is established between the electronic health insurance card (122) and the reading device (110), said communication link being a near-field link.

The invention relates to a communication method of an electronic health insurance card with a reading device, an electronic health insurance card, a reading device, and a computer program product.

The electronic health insurance card, abbreviated eHIC, has purportedly replaced the health insurance card in Germany since the beginning of the year 2006. The aim is to render more cost-effective, to simplify and to accelerate a data transmission between medical care providers, health insurance companies, drugstores and patients in the future. Among other things, this also includes the provision for access to an electronic doctor's letter, an electronic patient's file and for the electronic prescription with the aid of the electronic health insurance card. On the electronic health insurance card, only a certain amount of mandatory information is stored due to the small memory space available there. Thus, e.g., information on the identity of the patient, on the emergency care and optionally also notes, e.g. on the organ donor status of the patient are stored on the card. Documentation on the medications taken, the electronic doctor's letter, the electronic patient's file and the electronic prescription are accessed via secure access nodes to technical services of the telematics infrastructure.

DE 10 2004 051 296 B3 describes a method for storing data and for interrogating data, and corresponding computer program products. An individualized chip card enables a virtual patient's file to be stored on a data server. By using the chip card, data such as, e.g., a patient's file, can be transmitted encrypted to the data server from a surgery EDP system of a doctor's surgery.

From DE 102 58 769 A1, a further application of chip cards for patient's data is known.

Health insurance cards known from the prior art have contacts. This means that in order to use a chip card in the form of an electronic health insurance card, the latter must be introduced into a reading device of, e.g., a drugstore information system so that corresponding access to, for example, electronic prescription data is thereupon provided.

By comparison, the invention is based on the object of creating an improved communication method of an electronic health insurance card with a reading device, an improved electronic health insurance card, an improved reading device and an improved computer program product.

The objects forming the basis of the invention are in each case achieved by means of the features of the independent patent claims. Preferred embodiments of the invention are specified in the dependent patent claims.

According to the invention, a communication method for communication between an electronic health insurance card and a reading device is created, a communication link being established between the electronic health insurance card and the reading device, said communication link being a near-field link. According to one embodiment of the invention, the communication link is a secure communication link, i.e. a communication link in which, e.g., a secure messaging method is used.

The communication method according to the invention has the advantage that patients, for example in a drugstore, no longer need to introduce the electronic health insurance card into a corresponding reading device. In the past, this extra introduction of the chip card into the reading device has led to various problems. A major problem is the wear of the reading device since a reading process has to be carried out each time a patient is served in a drugstore. Due to the contactless communication method according to the invention, wear, both of health insurance cards and corresponding reading devices, is eliminated.

In the past, further problems resulted from the fact that either the patients themselves have introduced the health insurance card into the reading device or that patients have handed the health insurance card, e.g., to the drugstore personnel whereupon the latter have introduced the health insurance card into a corresponding reading device. Both these practices have proved to be time consuming in the past since in the case of an independent introduction of the health insurance card into the reading device, the health insurance card has often been introduced the wrong way around, that is to say with the wrong alignment of the chip relative to the reading head of the reading device, or because due to the searching for the health insurance card, for example from a purse of the patient, the handing over to the drugstore personnel, the reading out of the health insurance card by a corresponding reading device, the handing back of the health insurance card to the patient etc., valuable time was wasted which slowed down the actual process of serving a patient considerably.

All these disadvantages are avoided by using a contactless communication method.

According to one embodiment of the invention, the communication link is set up by an RFID method. RFID systems generally include both a transceiving unit on the part of the reading device and a transponder on the part of the RFID chip. The transponder is also called RFID label, RFID chip, RFID tag or radio label. RFID systems are radio frequency identification systems, so-called radio recognition systems. The communication between RFID transponder and reading device takes place typically via electromagnetic alternating high-frequency fields.

Using an RFID method has the advantage that the electronic health insurance card can be used without its own power supply. The transponder of the electronic health insurance card is supplied with power by an electromagnetic high-frequency field of the reading device, as a result of which an active power supply of the health insurance card can be dispensed with. This has several advantages. On the one hand, a patient no longer needs to worry about the “care” of the health insurance card after having been issued with and received his individualized health insurance card once. Once issued and activated, the card will perform its service for the entire period of issue of the card. Furthermore, using the RFID technology has the advantage that it can be implemented in miniaturized form in other devices and cards already existing: for example, it is possible to integrate the electronic health insurance card into an existing identification document using miniaturized RFID technology. For example, this provides the possibility of bonding onto an existing identification document such as, e.g., a driver's license, a thin foil which contains the RFID chip of the electronic health insurance card. In this case, it is left to every patient himself with which individualized card he wishes to combine the electronic health insurance card. In this context, e.g., credit cards, charge cards, driver's licenses, identity cards and many more are available. As an alternative, it is also possible to implement the RFID chip in wristwatches, mobile telecommunication devices etc. due to the small size of the RFID chip. A further possibility consists in implanting the RFID chip directly under the human skin. There is no health risk involved due to the small size of the RFID chip.

According to one embodiment of the invention, the communication method also comprises the step of authenticating the user of the electronic health insurance card with respect to the electronic health insurance card itself. This can be done in various ways.

According to one embodiment of the invention, a user identification is input at the reading device, followed by a request being transmitted for a remote check of the user identification from the reading device to the electronic health insurance card and the remote check of the user identification being carried out by the electronic health insurance card. “Remote check” is here understood to be a method in which the identification to be checked does not need to be transmitted directly, e.g. encrypted, to the health insurance card for the purpose of authentication but in which the check is performed by means of a protocol involving the reading device and the health insurance card. Corresponding protocols are known per se from the prior art such as, for example, Strong Password Only Authentication Key Exchange (SPEKE), Diffie-Hellman Encripted Key Exchange (DH-EKE), Bellovin-Merritt Protocol or Password Authenticated Connection Establishment (PACE).

According to a further embodiment of the invention alternative thereto, a user identification is input at the reading device, the user identification is encrypted by the reading device with a public health insurance card key of the health insurance card and the encrypted user identification is sent to the electronic health insurance card. The electronic health insurance card thereupon decrypts the received encrypted user identification, the decryption being effected by means of a private health insurance card key, the private health insurance card key being stored electronically in the electronic health insurance card, the public and the private health insurance card key forming an asymmetric cryptographic pair of keys, the registration being successful if the decrypted user identification has been verified by the health insurance card.

Authenticating the user of the electronic health insurance card with respect to the electronic health insurance card has the advantage that it is ensured that any misuse of stolen or lost electronic health insurance cards is largely prevented. It is exclusively the owner of the electronic health insurance card who, at the same time, also has the user identification, who is able to identify himself to the electronic health insurance card as being the rightful owner. In this context, for example, the use of a PIN which is input at the reading device or at a keyboard connected to the reading device can be considered as user identification. Similarly, it is possible to input as user identification a biometric feature of the owner of the electronic health insurance card. For example, this can be effected in the form of a fingerprint scan.

Due to the fact that for the purpose of secure communication, the user identification is encrypted with the public health insurance card key of the health insurance card, the data exchange between health insurance card and reading device is minimized. Negotiating keys is not required which is of advantage particularly with respect to the performance of RFID processors. Due to the chip card capabilities of an electronic health insurance card, which are provided in any case, the functionality that received data can be decrypted by the health insurance card by using the private health insurance card key is already implemented in each health insurance card. Implementing an additional functionality in the form of verifying a decrypted PIN therefore does not present any problems for an implementation in the form of an RFID chip since this does not need either high additional computing capacities or large additional storage space. To minimize the computing and storage capacity of the electronic health insurance card when using user identifications in the form of biometric features, it is a possibility, for example in fingerprint detection, to verify only a few features such as, e.g., the position of the fingerprint whorls, of the nodes, of the line ends etc.

According to a further embodiment of the invention, the public health insurance card key is called up from the health insurance card itself or from an external database. The latter is preferred for the above-mentioned reasons since by this means, the data exchange between health insurance card and reading device can be minimized. In the case of the public health insurance card key being called up from an external database, it would only be necessary to transmit a corresponding cryptic patient identification to the reading device from the health insurance card, on the basis of which the reading device can call up the public health insurance card key from the external database. It should be noted here that the concept of the electronic health insurance card provides for the use of public health insurance card keys in any case, so that an integration of the communication method according to the invention into existing telematics infrastructures is easily possible here without changing the infrastructure.

According to a further embodiment of the invention, the communication method furthermore comprises the step of authenticating the reading device with respect to the electronic health insurance card, wherein, after a successful authentication, data is enabled for data transmission from the health insurance card to the reading device, the data being stored on the health insurance card. Such an authentication of the reading device with respect to the electronic health insurance card has the advantage that a data exchange between the electronic health insurance card and the reading device only takes place at all if the health insurance card can be sure that the reading device is authorized at all for accessing the health insurance card. This effectively prevents an unnoticed contacting of the electronic health insurance card by any unauthorized reading devices. For example, it is thus not sufficient to obtain the correct PIN by continuously trying all possible combinations by means of a brute-force attack in the case of a PIN authentication of a user with respect to the health insurance card. The electronic health insurance card will exclusively communicate with those devices which can authenticate themselves as authorized with respect to the electronic health insurance card.

According to a further embodiment of the invention, the authentication comprises the steps of reception of a digital certificate by the electronic health insurance card from the reading device, checking of the certificate by the electronic health insurance card, the reading device being authenticated if the certificate check is successful. A successful certificate check is followed by the step of enabling the transmission of the data from the electronic health insurance card to the reading device, the data provided for the transmission being determined by the access authorizations specified in the certificate.

Checking the certificate by means of the electronic health insurance card, for example by using a public key infrastructure (PKI), ensures that the reading device is trustworthy. A user of the electronic health insurance card can thus be sure that only certified places will communicate with the electronic health insurance card.

As an alternative to using a public key infrastructure, it is also possible to store corresponding public keys and the certificates verifying the keys on the card itself so that the electronic health insurance card only needs to access internal storage areas for the certificate verification. Such a certificate check is known, for example, as “card-verifiable certificate (CVC)”.

Using certificates for authenticating the reading device with respect to the health insurance card also has the advantage that certificates, as a rule, also contain information on the permissible range of application and validity of the certificate. In other words, corresponding access authorizations are specified in the certificate so that the health insurance card can determine by means of the certificate which areas a corresponding reading device is allowed to access. Thus, it is desirable, e.g., that an attending doctor has access to the data area of the card whereas a drugstore information system is only allowed to access those areas which are necessary for handing out medication on the basis of an electronic prescription. Thus, e.g., a doctor would be allowed to access extensive electronic patient's files by using the electronic health insurance card whereas a drugstore information system is only allowed to access stored prescription data. It should be pointed out here that the prescription data and patient's files are not, or do not need to be, stored on the electronic health insurance card itself, but that the electronic health insurance card preferably contains only storage areas with corresponding references to externally stored data. This means that the access authorizations specified with the certificate preferably only allow corresponding memory references of the electronic health insurance card to be read out so that thereupon the data can be called up in the form of prescription data or patient's files from corresponding servers by means of the memory references.

According to one embodiment of the invention, after a successful certificate check, image data stored in the health insurance card are sent from the health insurance card to the reading device, the image data having at least one facial image of the owner of the health insurance card. The image contained in the image data is thereupon visually displayed on the reading device or on a data processing system connected to the reading device in order to provide for a visual check.

In other words, the photo of the patient stored on the patient's card is displayed, for example to a doctor or to a chemist, on a screen after a successful certificate check. As a result, the doctor or chemist can decide by means of a simple visual check whether the current owner of the health insurance card is also its rightful owner. The doctor will confirm and authorize a further access to the health insurance card with respect to the reading device or data processing system only when there is apparently no misuse of the electronic health insurance card. This method is advantageous especially because the patient does not need to perform any actions for using his electronic health insurance card in this case. Nevertheless, a misuse of the electronic health insurance card is almost impossible.

Using the electronic health insurance card without any interaction of its owner whatsoever has further advantages. For example, as mentioned above, emergency data such as, e.g., address data, next of kin, blood group, medication taken etc. can be stored on the health insurance card. In an emergency, it is thus possible for information on the patient to be displayed automatically on a display in an ambulance on arrival at the accident location without requiring a time-consuming searching of the patient for a corresponding patient's card. This makes it possible to gain valuable seconds, the attending doctor additionally being able to be sure to have been informed, e.g. about the correct blood group of precisely this patient at the accident location due to the display of the facial image of the patient.

A further field of application is, for example, also the extended use of the electronic health insurance card within hospitals. For example, planned examination procedures for a patient can be linked directly to his electronic health insurance card within a hospital. Thus, if, for example, a patient is firstly to be X-rayed in a department, it is sufficient if the patient only carries the health insurance card continuously with him. As soon as the patient appears in the X-ray area, the corresponding photo of the patient appears on a screen of the operating personnel so that they have direct access to the patient's file after a corresponding confirmation. This largely avoids erroneous, duplicated or unnecessary examinations since the operating personnel, e.g. of the X-ray department, due to the file provided in its complete form and thus also the doctor's corresponding provision for examinations, after a visual check of the patient, will only perform the examinations which are also noted in the patient's file linked to the health insurance card. This method can even be extended in such a way that corresponding medical interventions up to complex operations are linked to the electronic health insurance card. If a patient is being prepared for an operation and carries the electronic health insurance card with him then, attending doctors can find out without great effort whether the operating procedure being prepared is also intended for the patient currently being treated. This almost completely removes the risk of a patient mix-up due to the possibility of the visual check.

According to a further embodiment of the invention, the communication method also comprises the step of authenticating the user of the electronic health insurance card with respect to the electronic health insurance card itself, the steps of sending a user identification from the health insurance card to the reading device and the reception of a user input at the reading device being carried out after a completed certificate check, the user of the electronic health insurance card being successfully authenticated if the user identification matches the user input. In other words, this requires an interaction of a user, that is to say of a patient in order to provide or allow an access to the electronic health insurance card. The user identification can again be a PIN, a combination of letters or also an arbitrary biometric feature. The fact that the user identification is compared with the user input directly at the reading device ensures that an electronic health insurance card cannot be manipulated in such a way that a corresponding reading device is deceived and is of the opinion it is being presented with an electronic health insurance card authorized for communication which also belongs to the current user of the health insurance card.

According to a further embodiment of the invention, the communication method also comprises the step of registering the electronic health insurance card at the reading device, wherein, when registering, an identification is optically read from the electronic health insurance card by the reading device and a challenge-response method is carried out between the electronic health insurance card and the reading device, an encryption using the identification being carried out for an encryption in the challenge-response method.

This has the advantage that an owner of the electronic health insurance card is able to determine when a communication for reading data from the electronic health insurance card is taking place. This is because such a communication only takes place when the owner of the health insurance card actively holds the health insurance card, for example in front of a corresponding scanner. The identification, which is used for the encryption in the challenge-response method, can be any individualized machine-readable code. In this context, the identification can even be used directly as a key, for example. However, it is also possible to generate a corresponding symmetrical or asymmetric key from the identification by using corresponding algorithms, the challenge-response method running by using this key.

According to one embodiment of the invention, the identification is a public health insurance card key, a private health insurance card key furthermore being electronically stored in the electronic health insurance card itself, the public and the private health insurance card key forming an asymmetric cryptographic pair of keys. For example, the public health insurance card key can be printed on the health insurance card itself in the form of a two-dimensional barcode. This does represent any security risk since the public health insurance card key is publicly accessible in any case and does not allow any conclusions with respect to the identity of the patient.

To increase the security further during the use of the challenge-response method, the challenge-response method, according to a further embodiment of the invention, also comprises the step of receiving an authorization key at the reading device, of generating a session key by means of the identification and of the authorization key at the reading device and carrying out the challenge-response method by using the session key, the session key also being stored on the electronic health insurance card. For example, the authorization key can be a master key which is stored on a healthcare profession identification card of a health service provider. It is thus not sufficient to be only in possession of a corresponding reading device but the operating of the reading device for accessing the electronic patient's card additionally also requires the authorization key of the healthcare profession identification card. In this context, the authorization key of the healthcare profession identification card is a secret key which has been used as part of the individualization of the electronic health insurance card, together with the identification of the electronic health insurance card, for generating a session key which has been stored in a secure memory area of the electronic health insurance card. Depending on the algorithm used, it is here possible to use symmetric or asymmetric pairs of keys.

In a further aspect, the invention relates to a computer program product comprising instructions executable by a processor for carrying out the method steps of the communication method according to the invention.

In a further aspect, the invention relates to an electronic health insurance card, wherein the health insurance card has a near-field radio interface and is configured for near-field communication via a communication link with a reading device. The radio interface is preferably an RFID transponder.

According to one embodiment of the invention, the electronic health insurance card according to the invention is a chip card. As an alternative, it is also possible, as mentioned above, to configure the electronic health insurance card configured as an RFID chip in the form of adhesive foils or thin-film foils so that it is left to a patient on which bearer medium he intends to apply the electronic health insurance card.

In a further aspect, the invention relates to a reading device, wherein the reading device has a near-field radio interface and is configured for near-field communication via a communication link with an electronic health insurance card. Here, too, the radio interface is preferably an RFID transceiving unit.

According to one embodiment of the invention, the reading device is a connector. A connector is configured for establishing the communication between the electronic health insurance card, the doctor's or drugstore information system and the telematics infrastructure such as, e.g., a prescription server.

In the text which follows, embodiments of the invention are explained in greater detail with reference to the drawings, in which:

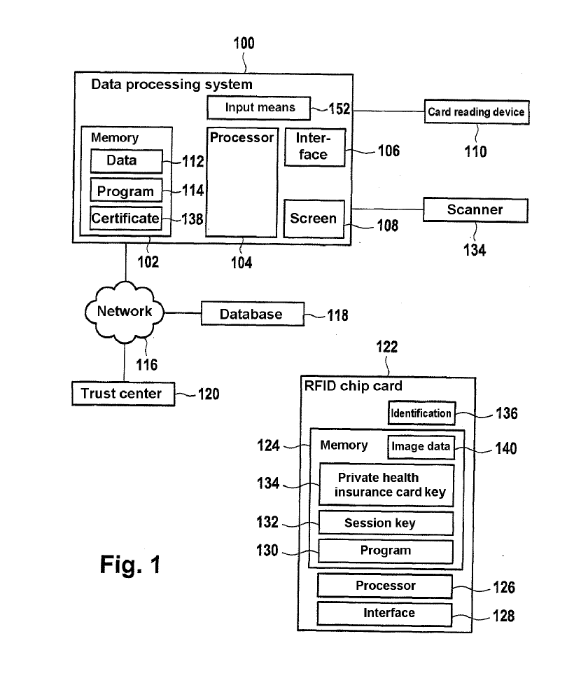

FIG. 1 shows a block diagram of a data processing system for contactless communication between an electronic health insurance card and a reading device;

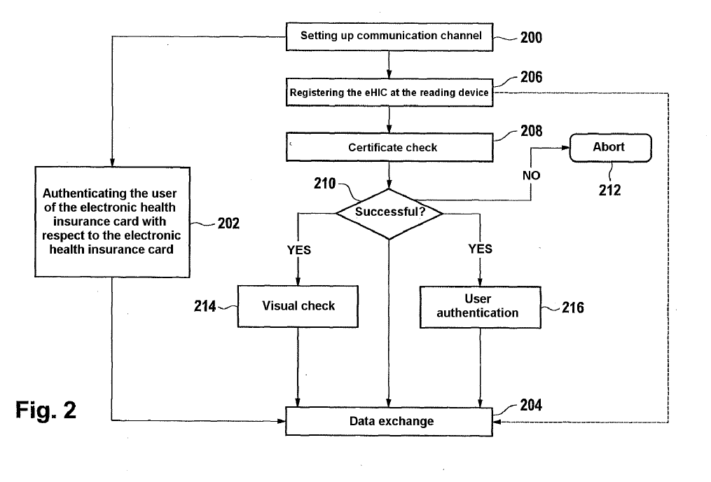

FIG. 2 shows a flowchart of various embodiments of communication methods between an electronic health insurance card and a reading device;

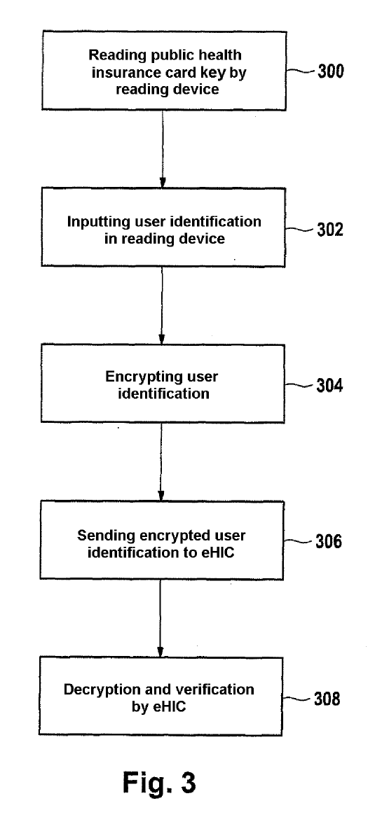

FIG. 3 shows a further flowchart for the authentication of a user of an electronic health insurance card with respect to the electronic health insurance card itself;

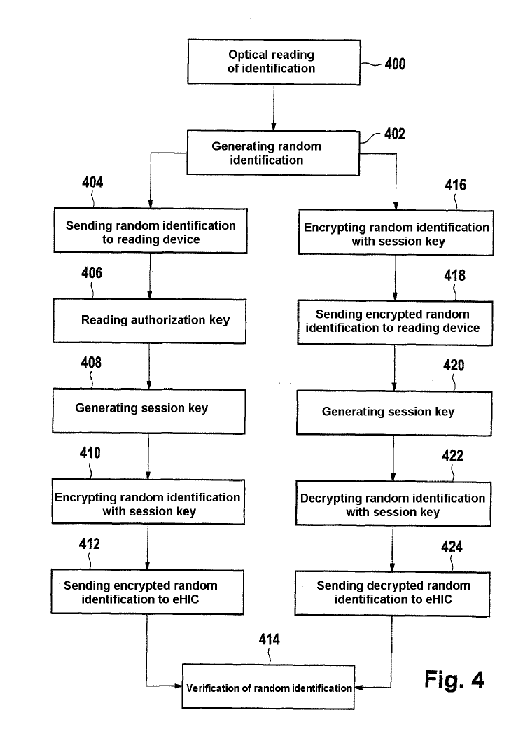

FIG. 4 shows a flowchart of a registration method of an electronic health insurance card at a reading device;

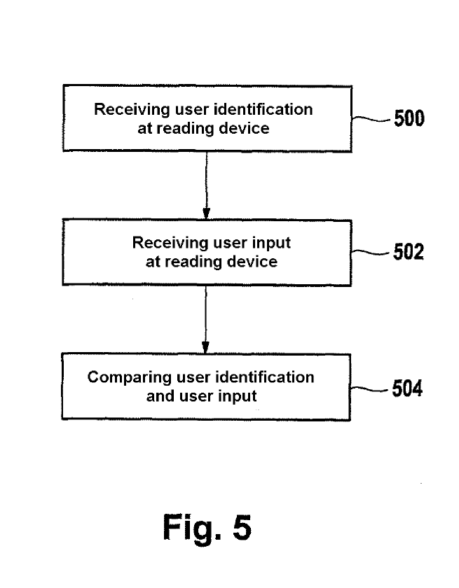

FIG. 5 shows a further flowchart for the authentication of a user of an electronic health insurance card with respect to the electronic health insurance card itself.

FIG. 1 shows a block diagram of a data processing system 100 for contactless communication between an electronic health insurance card 122 and a reading device 110. In this arrangement, the reading device 110 is coupled to the data processing system 100. For example, the data processing system 100 communicates with the card reading device 110 via its interface 106. As an alternative, the card reading device 110 can be connected to the data processing system 100 via a so-called connector. In this case, the so-called connector is usually connected to the data processing system 100 via the network 116.

Parts of the data processing system 100 can also be integrated in the reading device 110 or the reading device can be a component of the data processing system itself.

The data processing system 100 has input means 152 such as, e.g., a keyboard, a mouse etc. Furthermore, the data processing system 100 comprises a memory 102 and a processor 104. The memory 102 contains arbitrary data 112 and also program modules 114.

The processor 104 is used for executing the program modules 114. Furthermore, the data processing system 100 comprises output means in the form of, for example, a screen 108.

The data processing system 100 is furthermore connected to an external database 118 and to a trust sender 120 by a network 116 such as, e.g., the Internet. The database 118 is, e.g., a central prescription data server. As an alternative, the database 118 can also comprise a patient's file database if the data processing system 100 is part of a doctor's information system, for example in a hospital.

The card reading device 110 communicates wirelessly with the RFID chip card 122 which is configured as an electronic health insurance card. For this purpose, the chip card 122 has an interface 128, e.g. in the form of an RFID transponder. Furthermore, the RFID chip card 122 has a processor 126 and a memory 124. The memory 124 contains, among other things, program modules 130 which can be executed by the processor 126. Furthermore, the memory has a protected memory area in which a private health insurance card key 134 and a session key 132 are located stored.

The data processing system 100 is also connected to an optical scanner 134 by means of which an identification 136, e.g. in the form of a barcode, printed on the RFID chip card 122 can be scanned.

In the text which follows, the rough operation of a method of communication between the electronic health insurance card 122 and the data processing system 100, or its reading device 110, respectively, shall be outlined. According to one embodiment of the invention, after the transponder of the RFID chip card 122 has been activated by means of transmitting coils of the reading device 110, the user of the electronic health insurance card is authenticated with respect to the electronic health insurance card itself. As already mentioned above, this is helpful in preventing an unauthorized use of the electronic health insurance card, e.g. in the case of a theft or loss. For this purpose, for example, a secure communication channel is set up between the RFID chip card 122 and the reading device 110. A user of the RFID chip card inputs a user identification at the data processing system 100 with the aid of the input means 152. This user identification is thereupon encrypted with the public health insurance card key of the health insurance card in the form of the RFID chip card 122. In this context, the public health insurance card key can be called up, for example, from the database 118 via the network 116 by the data processing system 100. As an alternative, it is possible to read the public health insurance card key out of the memory 124 of the chip card 122.

The user identification is encrypted by means of an encryption algorithm which is implemented, e.g., in the form of a program module 114. If a so-called connector is used, the encryption and decryption take place in the connector. After encryption, the encrypted user identification is transmitted by the reading device 110 to the chip card 122. There, a decryption is carried out by using the private health insurance card key 134 by means of a corresponding decryption program which, for example, can be implemented as program module 130. In this case, the private and public health insurance card keys form an asymmetric cryptographic pair of keys. The RFID chip card 122, or the corresponding program module 130, will enable any further communication with the reading device 110 only if the user identification decrypted by the chip card corresponds to a corresponding user identification which is stored in a non-readable memory area on the RFID chip card. This ensures that any unauthorized access to the RFID chip card is effectively prevented.

Instead of using, for example, a PIN for the user identification, it is also possible to record biometric features by means of the input means 152. In this case, the input means 132 are a biometric scanner such as, e.g., a fingerprint scanner. In the case of recording, for example a fingerprint, the latter is digitized after the scan, encrypted as described above and transmitted to the RFID chip card for verification. However, as also described above, the biometric data to be transmitted are preferably reduced in this case since the memory and processor capacity of an RFID chip card is typically limited.

According to a further embodiment of the invention, a communication between the data processing system 100 and a chip card 122 can also take place in an alternative manner. For this purpose, an identification 136 is printed on the RFID chip card 122 for example. The data processing system 100 can then detect the identification 136 by means of the optical scanner 134. For example, the identification 136 is a two-dimensional barcode so that a high density of information is guaranteed in this case. An owner of the chip card 122 then takes the latter with the identification to the scanner 134 for the purpose of scanning. From the scanned identification 136, a program module 114 then generates a session key by using corresponding algorithms. This session key can either be the identification 136 itself, in which case it is possible to use the public health insurance card key of the RFID chip card 122 as identification 136. In this case, communication for the database 118 via the network 116 or with the chip card 122 via the air interface for the purpose of calling up the public health insurance card key is not necessary.

The data processing system 100 and the RFID chip card 122 can then carry out an authentication check by means of the session key by using a challenge-response method. Illustratively, this means, for example, that the electronic health insurance card generates a random identification, e.g. a random number. The random identification is conveyed to the data processing system 100 in plain language. The data processing system thereupon encrypts this random identification with the session key previously generated by using the identification 136. The generation of the session key also preferably includes an authorization key which was received, for example, from a health services ID card by means of the card reading device 110. However, the scanned identification is preferably transmitted to the health services ID card which is then able to generate the session key by using the authorization key.

After encryption of the received random number with the session key, the encrypted random number is transmitted back to the RFID chip card 122. Since the RFID chip card 122 also has stored the session key 132 in its memory 124, the RFID chip card can then decrypt the received encrypted random number again. If this is successful, it is verified that the data processing system 100 has previously scanned the identification 136 for generating the session key 132. It is thus clear that a communication between the chip card 122 and the data processing system 100 has occurred with the will of the owner of the chip card 122 since the latter himself has provided the chip card for scanning the identification 136.

It should be pointed out here that the session key 132 does not necessarily have to be a symmetric key. In this case, asymmetric cryptographic pairs of keys can also be used.

According to a further embodiment of the invention, a further security step for communication between the data processing system 100 and the RFID chip card is formed by the use of certificates. For example, the data processing system 100 contains a certificate 138 which is marked as trustworthy by the data processing system. As a rule, the certificate is located in the card reader since the latter, too, has a cryptographic identity. When a connector is used, the latter has a certificate in every case. For a communication between the data processing system 100 and the chip card 122, for example, the certificate 138 is transmitted to the chip card 122 from the data processing system 100. The certificate 138 is then checked by means of the program module 130. This can take place either by communication with the trust center 120 or by using corresponding root keys and certificates which themselves are stored in the memory 134 in a non-readable and secure memory area. After the successful checking and confirmation of the certificate 138, a further communication takes place between the data processing system 100 and the chip card 122. As also mentioned above, the certificate can contain, for example, certain access authorizations to data which are stored in the memory 124.

This comprises, for example, a further security stage in that, after a successful check of the certificate, image data 140 are transmitted from the chip card 122 to the data processing system 100. These image data contain, for example, a facial image of the owner of the chip card 122. After the image data 140 have been received by the data processing system 100, the image data are displayed on the screen 108. This provides a viewer of the screen 108, e.g. a chemist or a doctor, with a visual check whether the holder of the RFID chip card 122 is also actually its owner.

In yet another security stage, there is also the possibility, as an alternative, to transmit a corresponding identification to the data processing system 100 after the successful certificate check. This requires a high degree of safeguarding within the data processing system 100 so that an otherwise spying out or reading out of the transmitted identification by unauthorized persons is prevented. After this identification has been transmitted to the data processing system 100, a user identification can then be input by means of the input means 152 at the data processing system. This can take place, for example, again in the form of a PIN or also of a fingerprint scan or generally individual scan of a biometric feature. If the identification transmitted to the data processing system matches the user identification input, the data processing system 100 knows that the user of the RFID chip card is also its owner. This functionality can also be implemented in the so-called connector to which the PC, e.g. of the pharmacist is connected.

FIG. 2 shows a flowchart of various embodiments of communication methods between an electronic health insurance card and a reading device. After a communication channel has been set up between the health insurance card and the reading device in step 200, there are various test steps by means of which it is verified that, on the one hand, the reading device is authorized for an access to the health insurance card and, on the other hand, the carrier of the health insurance card is also authorized for using it.

In a first alternative, step 200 is followed by step 202 with the authentication of the user of the electronic health insurance card with respect to the electronic health insurance card itself. This authentication of step 202 comprises inputting a user identification at the reading device, encrypting this user identification and sending the encrypted user identification to the health insurance card where the user identification is verified. After a successful authentication, the data exchange between the reading device and the health insurance card finally takes place in step 204. Further details with respect to step 202 are explained in FIG. 3.

An alternative to carrying out step 202 in FIG. 2 is available in carrying out step 206, registering the electronic health insurance card at the reading device. This registering can take place, for example, by using an optically readable identification which is printed on the electronic health insurance card. This printed optical identification can be read by the reading device and used as the basis for a key for a challenge-response method between the health insurance card and the reading device. Since this requires the active involvement of the user of the electronic health insurance card, it is ensured that an unnoticed wireless radio access to the health insurance card is impossible since in this case the challenge-response method would fail due to the optically readable identification being unknown to the reading device. Further details for carrying out step 206 are found in FIG. 4.

After step 206 has been successfully carried out, there is a possibility of continuing directly with step 204, the data exchange between the health insurance card and the reading device. This could be appropriate, for example, when a carrier of the health insurance card, due to the given circumstances, can assume that the reading device is a trustworthy reading device with the greatest probability. This will be the case, for example, within a drugstore or a doctor's surgery. Under normal circumstances, a patient will not question the trustworthiness of a corresponding reading device here so that further authentication checks with respect to the access authorization of the reading device to the health insurance card are unnecessary for this purpose.

In a further alternative, there is the possibility of a certificate check in step 208 either after step 206 has been carried out with the registration of the health insurance card at the reading device or directly after step 200 without using step 206. This certificate check is a check of the certificate of the reading device so that in an automatic test method without any interaction of the carrier of the health insurance card, the health insurance card itself can determine whether the accessing reading device is trustworthy and whether, in consequence, a further access of the reading device to the health insurance card should be allowed. In this context, the certificate check in step 208 comprises the steps of receiving a digital certificate of the reading device through the electronic health insurance card and checking the certificate using the electronic health insurance card. The certificate used is here preferably a so-called card-verifiable certificate (CVC). A public key of a certifying entity, entered in the health insurance card, must be used for checking the signature of a CVC. As an alternative, however, there is the possibility that the health insurance card accesses a trust center via the reading device in order to carry out a certificate check by using the former.

If the certificate check in step 210 is successful, the transmission of data from the electronic health insurance card to the reading device is enabled. In this context, the data intended for transmission are determined by the access authorizations specified in the certificate. For example, a visual check can take place in step 214 after the successful certificate check in step 210. The visual check in step 214 requires that a facial image of the holder of the health insurance card is stored in the form of image data in the health insurance card itself. Should the certificate have an access authorization to image data of the owner of the health insurance card, the image data stored in the health insurance card are sent from the health insurance card to the reading device in step 214. The image contained in the image data is thereupon displayed visually at the reading device or at a data processing system connected to the reading device. This enables a health service provider to recognize visually and to decide whether the present holder of the health insurance card is also its rightful owner. If this is so, a data exchange can take place in step 204 after step 214.

As an alternative to carrying out the visual check in step 214, a user authentication can also be carried out in step 216 after a successful certificate check in step 210. In this case, the certificate contains an access authorization for reading a user identification from the health insurance card. This user identification of the health insurance card can then be compared with a user input at the reading device by means of which the reading device is able to decide whether the present user of the health insurance card is also authorized to use it. The successful user authentication in step 216 is again followed by the data exchange between health insurance card and reading device in step 204.

If the certificate check in step 210 is not successful, the communication between the reading device and the health insurance card is aborted by the health insurance card. Since this abortion in step 212 also takes place fully automatically due to the automatic certificate check, it is ensured that in the case of step 200 and following that step 208 being carried out, a “random trying-out” of various identifications for authenticating an unauthorized user with respect to the health insurance card can be effectively prevented.

A further security stage can also be obtained by the fact that, for example, after checking a certificate, an internal countdown can be started, only after the completion of which a further certificate check can take place. Thus, for example, the health insurance card can be configured for carrying out a certificate check only every 5 seconds. This prevents certificates from being “tried out” and “guessed” by using, for example, brute-force methods. This block of, for example, 5 seconds will not influence the use of the health insurance card in normal operation since it must be assumed that correctly certified reading devices are present. In this case, a repeated certificate check is thus not necessary at all.

FIG. 3 shows a further flowchart for the authentication of a user of an electronic health insurance card with respect to the electronic health insurance card itself. As already mentioned, steps 300 to 308 of FIG. 3 here correspond to step 202 in FIG. 2, namely the authentication of the user of the electronic health insurance card with respect to the electronic health insurance card itself. In step 300, the public health insurance card key of the health insurance card is read by the reading device. In this context, the public health insurance card key can be scanned and read either by an optical method from the surface of the health insurance card, it can be conveyed from the health insurance card to the reading device via near-field radio transmission or the reading device can interrogate the public health insurance card key from an external database. After step 300 has been carried out, the user at the reading device or at the data processing system, respectively, which is connected to the reading device, is requested to input some user identification for the electronic health insurance card. This user identification can be a biometric feature, it can be a PIN or any alphanumeric combination of characters and letters.

After the user identification has been input in step 302, the user identification is encrypted with the public health insurance card key by the reading device in step 34. In step 306, the encrypted user identification is sent to the electronic health insurance card which decrypts the encrypted user identification in step 308. In this context, the decryption is carried out with the private health insurance card key of the health insurance card. This requires that the public and private health insurance card key of the health insurance card form an asymmetric cryptographic pair of keys.

It should also be noted here that, instead of using the public and private health insurance card key for the encrypted communication between the reading device and the health insurance card, any other secure cryptographic methods can be used for a secure data transmission. The decisive factor is that a trusted channel is established between the health insurance card and the reading device.

FIG. 4 shows a flowchart of the registration method of an electronic health insurance card at a reading device. As already mentioned above, this registration method is carried out by using an optically readable identification which is printed on the electronic health insurance card. In this context, method steps 400 to 424 which are illustrated in FIG. 4 correspond to method step 206 of FIG. 2.

In step 400, the optical identification is read by the reading device or, respectively, by a corresponding scanner which is connected to the reading device. As already mentioned, the identification can be printed on the surface of the health insurance card in the form of a two-dimensional barcode. To further increase the protection against forgery of the electronic health insurance card here, it is also possible, instead of using a simple black/white print on the health insurance card, to apply the identification by using special pigmented dyes to the health insurance card. For example, fluorescent or phosphorescent dyes can be used. In this case, the identification can be excited into phosphorescent glowing by means of one light wavelength whereas reading out takes place on a light wavelength in the wavelength range of which the identification emits fluorescent or phosphorescent light.

After the optical identification has been read in step 400, a random identification is generated in step 402. This random identification is generated by the electronic health insurance card. There are then two different possibilities of how the method can be continued. One possibility is available in carrying out steps 404 to 412 and subsequently step 414, the other possibility is available in carrying out steps 416 to 424 and subsequently carrying out step 414.

When carrying out steps 404 to 412, the random identification generated by the health insurance card in step 402 is sent to the reading device. In step 406, the reading device reads a special authorization key, for example a master key. This master key can be, e.g., a special secret key of a health service ID card, which ensures that a registration of an electronic health insurance card at a reading device can only be successful when the reading device is also operated by an authorized user, e.g. a doctor or a pharmacist who is in possession of the health service ID card. Using the authorization key read and the identification read, the reading device generates a session key in step 408. Thereupon, the random identification is encrypted in step 410 with the session key generated in step 408 and transmitted to the electronic health insurance card in step 412.

Since the electronic health insurance card itself has the session key which is stored in a secure non-readable memory area of the health insurance card, the health insurance card is able to verify the random identification in step 414 in that it again decrypts the encrypted random identification and compares the value thus obtained with the random identification previously generated, which was conveyed to the reading device. The verification is successful when the decrypted random identification matches the generated random identification. The session key which is used for encrypting the random identification and its session key which is stored in the health insurance card do not necessarily need to be identical. This is only necessary when a symmetric key is used for cryptography. In the case of an asymmetric pair of keys, the session key generated in step 408, and the key used for verification of the random identification in step 414 are not identical due to their asymmetry.

As an alternative to carrying out steps 404 to 412 and step 414, it is also possible, as mentioned above, to carry out steps 416 to 424 followed by step 414. This will now be explained in greater detail. After the random identification has been generated by the health insurance card in step 402, this random identification is encrypted by the health insurance card with the session key stored in the health insurance card in step 416. The encrypted random identification is thereupon conveyed to the reading device by the health insurance card in step 418. In step 420, the reading device itself generates a session key, using the optically read identification (step 400). As an alternative or additionally, an authorization key can also be read here again which, together with the optical identification read is used for generating the session key in step 420. In step 422, the encrypted random identification is decrypted with the session key and the decrypted random identification is thereupon conveyed back to the electronic health insurance card in step 424. The health insurance card can then verify again in the subsequent step 414 whether the received random identification corresponds to the random identification generated in step 402 which provides a verification.

FIG. 5 shows a further flowchart for the authentication of a user of an electronic health insurance card with respect to the electronic health insurance card itself. In this context, carrying out steps 500 to 504 corresponds to step 216 of FIG. 2. As explained in FIG. 2, carrying out steps 500 to 504 firstly presupposes a successful certificate check of the reading device. The reason is that the electronic health insurance card conveys a user identification to the reading device in step 500. In other words, this means that an information item actually known only to the health insurance card leaves the latter for the purpose of a user authentication. This mandatorily requires that such a user identification is only conveyed to those reading devices at which the user of the health insurance card or the health insurance card itself, respectively, can be sure that they are trustworthy. On the other hand, this naturally requires that any manipulation of the reading device must be reliably prevented so that reading out of the user identification transmitted to the reading device is prevented.

After the user identification is received at the reading device in step 500, a user input is received at the reading device in step 502. This user input can be, for example, a PIN, an alphanumeric combination of characters or also a biometric feature. For example, a fingerprint scan of the user of the electronic health insurance card is carried out in step 502. Following this, the user input, that is to say, for example, the scanned fingerprint, is compared in step 504 with the user identification which was received by the health insurance card itself in step 500. If in the example of a fingerprint, the fingerprint which was conveyed to the reading device from the health insurance card and the fingerprint which was received by the reading device in the form of the user input match one another, the reading device can be sure that the present user of the health insurance card is also its rightful owner.

Using biometric features in conjunction with a user authentication as part of the electronic health insurance card is advantageous in a special manner. This completely eliminates the necessity that a user, the owner of the electronic health insurance card, needs to remember, for example, a PIN as in the case of many other electronic cards. In spite of the non-requirement of a PIN, maximum security is guaranteed with respect to an unauthorized reading-out of data from the health insurance card. The non-requirement of a PIN is especially relevant against the background of the typical use of electronic health insurance cards. Elderly people who often use a health insurance card due to their susceptibility to illness are spared the problem that they need to remember a PIN which often leads to considerable difficulties due to increased forgetfulness, especially at an advanced age. In families with children, too, where usually every individual person covered by health insurance has their own insured-person card, that is to say their own electronic health insurance card, there is no necessity that, for example, a single mother must remember several different PINs for herself and her children. In this case, a flexible and highly secure use of the electronic health insurance card according to the invention is possible by using personal, individual biometric features.

It should also be noted here that various security mechanisms mentioned can be combined with one another for the purpose of a flexible use of the electronic health insurance card. For example, it is conceivable to combine the input of a PIN as described, for example, in step 202 in FIG. 2, in conjunction with a visual check, step 214. That is to say, for the communication between the electronic health insurance card and the reading device, either step 202 is used or steps 208, 210 and 214. If step 202 is used, that is to say the simple PIN input for authenticating a user of the health insurance card with respect to the health insurance card itself, the health insurance card can also be given, for example, to carriers who, knowing the PIN and holding the health insurance card can go to a drugstore in order to procure an electronic prescription for the person in care. If the visual check is combined with the authentication of the user via an identification, e.g. a PIN, an image of the owner of the health insurance card would first appear on the screen of the drugstore information system in a drugstore. The pharmacist thereupon recognizes that the facial image conveyed by the health insurance card does not match the appearance of the current user of the health insurance card. A drugstore employee can thereupon request the user of the health insurance card to alternatively input a PIN in order to authenticate himself with respect to the health insurance card and, if necessary, also to the reading device.

### LIST OF REFERENCE DESIGNATIONS

100 Data processing system
102 Memory
104 Processor
106 Interface
108 Screen
110 Reading device
112 Data
114 Program
116 Network
118 Database
120 Trust center
122 Chip card
124 Memory
126 Processor
128 Interface
130 Program
132 Session key
134 Private health insurance card key
136 Identification
138 Certificate
140 Image data
152 Input means

What is claimed is:

1-38. (canceled)

39. A communication method of an electronic health insurance card with a reading device, the method comprising:
establishing a communication link between the electronic health insurance card and the reading device, said communication link being a near-field link,
registering the electronic health insurance card at the reading device, the following steps being carried out when registering:
optically reading an identification from the electronic health insurance card by the reading device,
carrying out a challenge-response method between the electronic health insurance card and the reading device, an encryption using the identification being carried out for an encryption in the challenge-response method,
the identification being a public health insurance card key, a private health insurance card key furthermore being electronically stored in the electronic health insurance card, the public and the private health insurance card key forming an asymmetric cryptographic pair of keys,
the challenge-response method comprising the following steps:
reception of a digital certificate by the electronic health insurance card from the reading device,
checking of the certificate by the electronic health insurance card, the reading device being authenticated if the certificate check is successful,
after a successful authentication:
enabling the transmission of data from the electronic health insurance card to the reading device, the data transmission being enabled according to the access authorizations specified in the certificate,
transmitting image data stored in the health insurance card from the health insurance card to the reading device, the image data having at least one facial image of the owner of the health insurance card,
displaying the facial image from the image data on the reading device or on a data processing system connected to the reading device in order to provide for a visual check.

40. The communication method as claimed in claim 39, wherein the communication link is set up by an RFID method.

41. The communication method as claimed in claim 39 wherein the communication link is a secure communication link.

42. The communication method as claimed in claim 39, wherein the authentication further comprises the following steps:
inputting a user identification at the reading device,
transmitting a request for a remote check of the user identification from the reading device to the electronic health insurance card,
carrying out the remote check of the user identification by the electronic health insurance card.

43. The communication method as claimed in claim 39, wherein the authentication further comprises the following:
inputting a user identification at the reading device,
encryption of the user identification by the reading device with a public health insurance card key of the health insurance card,
sending of the encrypted user identification to the electronic health insurance card,
decryption of the received encrypted user identification by the health insurance card, the decryption being effected by means of a private health insurance card key, the private health insurance card key being stored electronically in the electronic health insurance card, the registration being successful if the decrypted user identification has been verified by the health insurance card.

44. The communication method as claimed in claim 43, wherein the public health insurance card key is called up from the health insurance card or from an external database.

45. The communication method as claimed in claim 39, also comprising the step of authenticating the user of the electronic health insurance card with respect to the electronic health insurance card, wherein the following steps are carried out after a successful certificate check:
sending a user identification from the health insurance card to the reading device,
reception of a user input at the reading device, the user of the electronic health insurance card being successfully authenticated if the user identification matches the user input.

46. The communication method as claimed in claim 45, the user identification being a biometric feature.

47. The communication method as claimed in claim 39, wherein the challenge-response method also comprises the following steps:
reception of an authorization key at the reading device,
generation of a session key by means of the identification and of the authorization key at the reading device,
carrying out the challenge-response method by using the session key, the session key also being stored on the electronic health insurance card.

48. The communication method as claimed in claim 39, wherein the identification is printed coded as barcode on the electronic health insurance card.

49. An electronic health insurance card, the electronic health insurance card comprising:
a near-field radio interface, the near-field radio interface configured for near-field communication via a communication link with a reading device,
a registration component which registers the electronic health insurance card at the reading device, the registration component comprising:
an optically readable identification,
a challenge-response component, the challenge-response component configured to carry out an encryption between the electronic health insurance card and the reading device by using the identification,
the identification being a public health insurance card key, a private health insurance card key furthermore being electronically stored in the electronic health insurance card, the public and the private health insurance card key forming an asymmetric cryptographic pair of keys,
the challenge-response component comprising:
a receiving component, the receiving component receiving a digital certificate from the reading device,
a checking component, the checking component for checking the certificate, wherein the reading device is authenticated to the electronic health insurance card if the certificate check is successful,
image data stored in the electronic health insurance card, the image data having at least a facial image of the owner of the health insurance card,
having successfully authenticated the reading device to the electronic health insurance card:
a transmission enabling component, the transmission enabling component enabling the transmission of data to the reading device after a successful authentication, the data transmission being enabled according to access authorizations specified in the certificate,
an image transmission component, the image transmission component transmitting the image data to the reading device after a successful authentication.

50. The electronic health insurance card as claimed in claim 49, the near-field radio interface being an RFID transponder.

51. The electronic health insurance card as claimed in claim 49, also comprising a remote check component, the remote check component capable of receiving a request for a remote check of a user identification from the reading device and performing the remote check of the user identification.

52. The electronic health insurance card as claimed in claim 49, also comprising:
the receiving component additionally receiving an encrypted user identification from the reading device,
a decryption component, the decryption component decrypting the received encrypted user identification with the private health insurance card key,
a verification component, the verification component verifying the user identification, wherein an authentication of the user of the electronic health insurance card with respect to the electronic health insurance card is successful if the decrypted user identification has been verified.

53. The electronic health insurance card as claimed in claim 52, also comprising a sending component, the sending component sending a public health insurance card key to the reading device.

54. The electronic health insurance card as claimed in claim 49, also comprising a user authentication component, the user authentication component for authenticating the user of the electronic health insurance card with respect to the electronic health insurance card, the user authentication component configured to send a user identification to the reading device for verification by the reading device after a successful certificate check.

55. The electronic health insurance card as claimed in claim 54, wherein the user identification is a biometric feature.

56. The electronic health insurance card as claimed in claim 49, wherein the challenge-response component is configured for carrying out the encryption by using a session key stored on the electronic health insurance card, wherein the session key can be derived from the identification and an authorization key of the reading device.

57. The electronic health insurance card as claimed in claim 49, wherein the identification is printed as a barcode on the electronic health insurance card.

58. The electronic health insurance card as claimed in claim 49, wherein the electronic health insurance card is a chip card.

59. A tangible computer readable medium encoded with a program, the program capable of execution on a computer, the program comprising the steps of:
establishing a communication link between the electronic health insurance card and the reading device, said communication link being a near-field link,
registering the electronic health insurance card at the reading device, the following steps being carried out when registering:
optically reading an identification from the electronic health insurance card by the reading device,
carrying out a challenge-response method between the electronic health insurance card and the reading device, an encryption using the identification being carried out for an encryption in the challenge-response method,
the identification being a public health insurance card key, a private health insurance card key furthermore being electronically stored in the electronic health insurance card, the public and the private health insurance card key forming an asymmetric cryptographic pair of keys,
the challenge-response method comprising the following steps:
reception of a digital certificate by the electronic health insurance card from the reading device,
checking of the certificate by the electronic health insurance card, the reading device being authenticated if the certificate check is successful,
after a successful authentication:
enabling the transmission of data from the electronic health insurance card to the reading device, the data transmission being enabled according to the access authorizations specified in the certificate,
transmitting image data stored in the health insurance card from the health insurance card to the reading device, the image data having at least one facial image of the owner of the health insurance card,
displaying the facial image from the image data on the reading device or on a data processing system connected to the reading device in order to provide for a visual check
